(19) United States
(12) Patent Application Publication
(10) Pub. No.: US 2022/0164358 A1
(43) Pub. Date: May 26, 2022

(54) IDENTIFYING USERS OF INTEREST VIA ELECTRONIC MAIL AND SECONDARY DATA ANALYSIS

(71) Applicant: BANK OF AMERICA CORPORATION, Charlotte, NC (US)

(72) Inventors: Jack Lawson Bishop, III, Evanston, IL (US); Amela Gjishti, Chicago, IL (US); Michael Ogrinz, Easton, CT (US); Jason Conrad Starin, Huntersville, NC (US)

(73) Assignee: BANK OF AMERICA CORPORATION, Charlotte, NC (US)

(21) Appl. No.: 17/100,437

(22) Filed: Nov. 20, 2020

(51) Int. Cl. G06F 16/2457

(52) U.S. Cl. CPC G06F 16/24573; G06F 16/24578

(57) ABSTRACT

Email metadata, and in some embodiments other secondary data, is analyzed to identify users of interest defined as having knowledge or expertise in a subject matter. Specifically, a corpus of email metadata is analyzed to determine, at least, which subject matters are associated with users, which users received or transmitted subject matter-specific emails, the distribution groups to which users, and any other relevant email metadata. In additional embodiments, secondary data other than email metadata is also analyzed and used to identify the users of interest. The analyzed email metadate, and in some embodiments the secondary data, is used to render reputation indicator(s) for each user that indicate a level of knowledge/expertise that the user possesses on subject matter(s). A requester provides input criteria including the subject matter, and, in response, is presented a ranked user listing that is ranked based on the level of reputation indictor.

### FIELD OF THE INVENTION

The present invention relates to electronic mail analysis and, more specifically, using electronic mail metadata analysis and, in some embodiments other related data analysis, to determine users of interest.

### BACKGROUND

Typically, manual efforts are employed to locate an individual or group of individuals that meet a specific need, e.g., so called Subject Matter Experts (SMEs) or the like. In many instances these efforts are not only time consuming but fail to result in identifying the correct individual(s). In this regard, merely asking individuals for recommendations or soliciting an entire organization or employee base for individual(s) to identify themselves may not result in finding the individuals who are the best match and/or most qualified for the requester's specific need. In both of these instances, internal politics or self-promotion may influence who an individual recommends or which individuals step forward and proclaim to be the individual(s) that meet the requester's needs.

In other instances, requesters rely on available internal resources, such as employee databases, organization hierarchy charts or the like to identify individual(s) that meet the requester's need. However, such resources typically provide the requester with a very limited amount of knowledge as to individual capabilities and insight. Specifically, such resources do not provide a requester insight into which individual is the most knowledgeable in a specific area nor do such resources allow for the requester to assess timeframes of knowledge (i.e., which individual(s) are currently the most knowledgeable or which in individual was most knowledgeable during a specified historical time period).

Further, in many instances the requester demands immediate identification of the most knowledgeable individual(s) on a specific topic or subject matter. Soliciting recommendations and/or searching through internal resources are time consuming efforts that not only provide inaccurate results but also do not provide the immediacy required in certain instances.

Therefore, a need exists to develop fully automated systems, methods and the like that accurately identify individual(s) that are most knowledgeable in a specific area, matter, topic or field. In this regard, the systems and methods should eliminate the subjectivity that is rampant in manual processes that entail soliciting others for recommendations and the inaccuracy provided from merely searching organization hierarchy charts and the like. Moreover, the desired systems, method and the like should provide for a requester to identify the most knowledgeable individuals on-demand to meet the immediacy required of certain requests.

### SUMMARY OF THE INVENTION

The following presents a simplified summary of one or more embodiments in order to provide a basic understanding of such embodiments. This summary is not an extensive overview of all contemplated embodiments and is intended to neither identify key or critical elements of all embodiments, nor delineate the scope of any or all embodiments. Its sole purpose is to present some concepts of one or more embodiments in a simplified form as a prelude to the more detailed description that is presented later.

Embodiments of the present invention address the above needs and/or achieve other advantages by utilizing email metadata to determine users of interest (i.e., users with a specified expertise in a subject matter or topic). In specific embodiments of the invention, email metadata along with other related data sources are used to determine the users of interest. In this regard, the present invention provides for analyzing a corpus of email metadata to determine, from subject line content, date of message, subject matters of interest (e.g., specific topics or the like), the distribution of emails associated with subject matters of interest (i.e., which users/individuals received or transmitted emails of a specific topic and the distribution groups to which users/individuals belong.

Based at least on the aforementioned data determined from analyzing the email metadata, the invention provides for creating, for each user/individual, reputation indicators, otherwise referred to as reputation scores for each subject matter that is applicable to the corresponding user/individual. The reputation indicators serve to quantify the temporally-focused level of knowledge or degree of relevancy that the user has in the subject matter.

Subsequently, when a requester desires to know which individuals are most knowledgeable in a specific subject matter, the requester accesses a user interface that is configured to receive input criteria that includes, at least, the subject matter and, in response, the invention provides the user with a listing of users that is ranked based on their respective reputation indicator for the specified subject matter (e.g, the user with highest reputation indicator, i.e., the user identified as the most knowledgeable in subject matter, is ranked first, the user with next highest reputation indicator is ranked second and so on).

In specific embodiments of the invention, email metadata along with other related data sources are used to determine the users of interest.

As such the present invention is able to systematically and accurately identify users/individual(s) that are most knowledgeable in a specific subject matter for a specified time period. By eliminating the need to solicit for recommendations as to which individuals are most knowledgeable on a specific subject matter, the present invention eliminates the subjectivity of such manual determinations. Moreover, the present invention eliminates the inefficiencies evident in such manual determination by providing a system that is capable of providing requesters the ability to ascertain, immediately after submitting a response, which user(s) are currently or for a specified historical period most knowledgeable in subject area.

A system for identifying users of interest though analysis of electronic mail (email) defines first embodiment of the invention. The system includes a plurality of computing apparatus, e.g., servers and the like, that in network communication with one another and include a memory and one or more processors in communication with the memory. The system includes an email repository that is stored in the memory and configured to store email that has been transmitted and received by a plurality of users. The email includes metadata comprising (i) subject line content, (ii) email recipient and sender data, and (iii) distribution group membership and other data that does not include the body/contents of the emails themselves.

The system further includes an email metadata analyzation engine that is stored in the memory and executable by one or more of the processors. The email metadata analyzation engine is configured to access the email repository and analyze only the metadata of the emails to determine, for each user, (i) an association between a user and one or more subject matters identified from subject line content, (ii) emails associated with each of the one or more subject matters received and transmitted by the user, and (iii) distribution groups to which the user is a member.

The system additionally includes a reputation indicator determination engine that is stored in the memory and executable by one or more of the processors. The reputation indicator determination engine is configured to determine for each of the users one or more reputation indicators. Each reputation indicator is associated with a subject matter and is based at least on (i) volume of emails associated with the subject matters that have been received and transmitted by the user, and (ii) distribution groups to which the user is a member. As discussed below, further factors resulting from data other than email metadata may be considered and used to determine reputation indicators.

Moreover, the system includes a user identifier engine that is stored in the memory and executable by one or more of the processors. The user identifier engine provides a requester with a user interface (UI) configured to receive input criteria that identifies at least a subject matter. In response to receiving the input criteria, the user identifier engine is configured to determine, and present to the requester via the UI, a ranked user listing for the subject matter. The ranked user listing comprises one or more users ranked based on a level of the reputation indicator for the subject matter (i.e., the user associated with the highest level of the reputation indicator is listed first and so on).

In specific embodiments the system includes one or more secondary data repositories stored in the memory and configured to store data associated with the plurality of users, and one or more data analyzation engines that are stored in the memory and executable by one or more of the processors. The data analyzation engines are configured to access one or more of the secondary data repository engines and analyze the data to determine associations between the subject matters and users. In such embodiments of the system, the reputation indicator determination engine is further configured to determine for each of the users one or more reputation indicators, each of which is associated with a subject matter and is based further on the associations between the subject matter and the user as determined from the data stored in the secondary data repositories.

In related embodiments of the system, the secondary data repositories may be an internal user data repository, such as, but not limited to a software development repository, certification repository, education credential repository, publication repository, group membership repository or the like. In further embodiments of the system, the secondary data repositories may be an external data repository, such as website or the like that provides data on user qualifications, publications or the like.

In further specific embodiments the system includes an automated scheduler stored in the memory, executable by the processor and configured to execute the email metadata analyzation engine and, in some embodiments, the one or more data analyzation engines on a predetermined schedule or in response to a trigger event. In related embodiments the system may include a plurality of coordinators, with each coordinator associated with a corresponding metadata/data analyzation engine. The coordinators are configured to logically synchronize actions performed by two or metadata/data analyzation engines.

In still further related embodiments of the invention, the secondary data repository comprises a source code repository that is configured to store source code developed by a plurality of the users and data associated therewith. In such embodiments of the system, the reputation indicator determination is further configured to determine for each of the users the one or more reputation indicators such that, at least one of the reputation indicators is further based on the subject matters associated with the user identified from the control flow of the source code.

In additional specific embodiments of the system, the user identifier engine is further configured to receive input criteria from a requester that identifies other user criteria and determine the ranked user listing for the subject matter based further on the other user criteria.

In still further specific embodiments of the system, the user identifier engine is further configured to receive input criteria from a requester that identifies a period of time associated with the ranked user listing for the subject matter and determine the ranked user listing for the subject matter over the identified period of time.

Moreover, in additional embodiments of the system, the user identifier engine is further configured to determine at least one of current and future availability of the users in the ranked user listing and provide such information to the requester along with the listing.

In additional specific embodiments of the system, the user identifier engine is further configured to receive input criteria from a requester that identifies a plurality of subject matters needed to form a team of users, and, in response to receiving the input criteria, determine, and present to the requester, at least one of (i) a plurality of ranked user listings for each of the plurality of subject matter, wherein the ranked user listings comprises one or more users ranked based on a level of the reputation indicator for the subject matter, and (ii) a team of users, each user in the team determined based at least on the level of the reputation indicator for one of the plurality of subject matters.

A computer-implemented method for identifying user of interests though analysis of electronic mail (email) defines second embodiments of the invention. The method is executed by one or more computer processing devices. The method includes accessing an email repository and analyzing only the metadata of the emails to determine, for each user, (i) an association between a user and one or more subject matters identified from subject line content, (ii) emails associated with each of the one or more subject matters received and transmitted by the user, and (iii) distribution groups to which the user is a member. Further, the method includes determining for each of the users one or more reputation indicators. Each reputation indicator is associated with a subject matter and is based at least on (i) volume of emails associated with each of the subject matters that have been received and transmitted by the user, and (ii) distribution groups to which the user is a member. Additionally, the method includes receiving input criteria from a requester that identifies a subject matter and, in response, determining, and presenting to the requester, a ranked user listing for the subject matter. The ranked user listing comprises one or more users ranked based on a level of the reputation indicator for the subject matter (i.e., the user with most knowledge or highest degree of relevancy to the subject matter is ranked first, the user with the second most knowledge or second highest relevancy to the subject matter is ranked second and so on).

In specific embodiments the computer-implemented method further includes accessing one or more of the secondary data repository engines and analyzing the data to determine associations between the subject matters and users. In such embodiments of the method, determining for each of the users the one or more reputation indicators further includes determining for each of the users the one or more reputation indicators based further on the associations between the subject matter and the user determined from the data stored in the secondary data repositories. In related embodiments the method includes performing (i) accessing the email repository and analyzing only the metadata of the emails, and (ii) accessing one or more of the secondary data repository engines and analyzing the data, on a predetermined schedule or in response to a trigger event and/or logically synchronizing (i) accessing the email repository and analyzing only the metadata of the emails, and (ii) accessing one or more of the secondary data repository engines and analyzing the data.

In further specific embodiments of the computer-implemented method, receiving the input criteria from the requester further includes receiving the input criteria from the requester that identifies a period of time (e.g., current time period or historical time period) associated with the ranked user listing for the subject matter and determining the ranked user listing for the subject matter further includes determining the ranked user listing for the subject matter over the identified period of time.

A computer program product including non-transitory computer-readable medium defines third embodiments of the invention. The computer-readable medium includes a first set of codes for causing a computer to access an email repository and analyze only the metadata of the emails to determine, for each user, (i) an association between a user and one or more subject matters identified from subject line content, (ii) emails associated with each of the one or more subject matters received and transmitted by the user, and (iii) distribution groups to which the user is a member. The computer-readable medium additionally includes a second set of codes for causing a computer to determine for each of the users one or more reputation indicators. Each reputation indicator is associated with a subject matter and is based at least on (i) volume of emails associated with each of the subject matters that have been received and transmitted by the user, and (ii) distribution groups to which the user is a member. Further, the computer-readable medium includes a third set of codes for causing a computer to receive input criteria from a requester that identifies a subject matter and a fourth set of codes for causing a computer, in response to receiving the input criteria, determine, and present to the requester, a ranked user listing for the subject matter, wherein the ranked user listing comprises one or more users ranked based on a level of the reputation indicator for the subject matter.

In further embodiments the computer program product, the computer-readable medium further includes a fifth set of codes for causing the computer to access one or more of the secondary data repository engines and analyzing the data to determine associations between the subject matters and users. In such embodiments of the computer program product, the second set of codes is further configured to determine for each of the users the one or more reputation indicators based further on the associations between the subject matter and the user determined from the data stored in the secondary data repositories.

In other specific embodiments of the computer program product, the computer-readable medium further includes a sixth set of codes for causing a computer to perform (i) accessing the email repository and analyzing only the metadata of the emails, and (ii) accessing one or more of the secondary data repository engines and analyzing the data on a predetermined schedule or in response to a trigger event and/or a seventh set of codes for causing a computer to logically synchronize (i) accessing the email repository and analyzing only the metadata of the emails, and (ii) accessing one or more of the secondary data repository engines and analyzing the data.

In additional specific embodiments of the computer program product, the fourth set of codes is further configured to cause the computer to receive the input criteria from the requester that identifies a period of time associated with the ranked user listing for the subject matter, and the fifth set of codes is further configured to determine the ranked user listing for the subject matter over the identified period of time.

Thus, systems, methods, and computer program products herein described in detail below provide for utilizing email metadata to determine users of interest (i.e., users with a specified expertise in a subject matter or topic). Specifically, the present invention provides for analyzing a corpus of email metadata to determine (i) subject matters (e.g., specific topics or the like), (ii) the distribution of emails associated with subject matters of interest (i.e., which users/individuals received or transmitted emails of a specific topic, (iii) the distribution groups to which users/individuals belong, and (iv) any other relevant email metadata.

### BRIEF DESCRIPTION OF THE DRAWINGS

Having thus described embodiments of the invention in general terms, reference will now be made the accompanying drawings, wherein:

FIG. 1 is a schematic/block diagram of a system for identifying users of interest via electronic mail metadata analysis, in accordance with embodiments of the present invention;

FIG. 2 is a detailed block diagram of a computing apparatus configured for identifying users of interest via electronic mail metadata analysis, platform for prioritizing and validating open source software using an evolutionary/genetic platform, in accordance with embodiments of the present invention;

FIG. 3 is a schematic/flow diagram of a system for identifying users of interest via electronic mail metadata analysis, in accordance with embodiments of the present invention;

FIG. 4 is a schematic/flow diagram of a system for identifying users of interest via electronic mail metadata and supplementary data analysis, in accordance with embodiments of the present invention;

FIG. 5 is a schematic/flow diagram of a system identifying users of interest via electronic mail metadata and source code-related data analysis, in accordance with embodiments of the present invention and

FIG. 6 is a method for identifying users of interest via electronic mail metadata analysis, in accordance with embodiments of the present invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to like elements throughout.

As will be appreciated by one of skill in the art in view of this disclosure, the present invention may be embodied as an apparatus (e.g., a system, computer program product, and/or other device), a method, or a combination of the foregoing. Accordingly, embodiments of the present invention may take the form of an entirely hardware embodiment, an entirely software embodiment (including firmware, resident software, micro-code, etc.), or an embodiment combining software and hardware aspects that may generally be referred to herein as a “system.” Furthermore, embodiments of the present invention may take the form of a computer program product comprising a computer-usable storage medium having computer-usable program code/computer-readable instructions embodied in the medium.

Any suitable computer-usable or computer-readable medium may be utilized. The computer usable or computer-readable medium may be, for example but not limited to, an electronic, magnetic, optical, electromagnetic, infrared, or semiconductor system, apparatus, or device. More specific examples (e.g., a non-exhaustive list) of the computer-readable medium would include the following: an electrical connection having one or more wires; a tangible medium such as a portable computer diskette, a hard disk, a time-dependent access memory (RAM), a read-only memory (ROM), an erasable programmable read-only memory (EPROM or Flash memory), a compact disc read-only memory (CD-ROM), or other tangible optical or magnetic storage device.

Computer program code/computer-readable instructions for carrying out operations of embodiments of the present invention may be written in an object oriented, scripted, or unscripted programming language such as PYTHON, JAVA, PERL, SMALLTALK, C++, SPARK SQL, HADOOP HIVE or the like. However, the computer program code/computer-readable instructions for carrying out operations of the invention may also be written in conventional procedural programming languages, such as the “C” programming language or similar programming languages.

Embodiments of the present invention are described below with reference to flowchart illustrations and/or block diagrams of methods or apparatuses (the term “apparatus” including systems and computer program products). It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a particular machine, such that the instructions, which execute by the processor of the computer or other programmable data processing apparatus, create mechanisms for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instructions, which implement the function/act specified in the flowchart and/or block diagram block or blocks.

The computer program instructions may also be loaded onto a computer or other programmable data processing apparatus to cause a series of operational events to be performed on the computer or other programmable apparatus to produce a computer implemented process such that the instructions, which execute on the computer or other programmable apparatus, provide events for implementing the functions/acts specified in the flowchart and/or block diagram block or blocks. Alternatively, computer program implemented events or acts may be combined with operator or human implemented events or acts in order to carry out an embodiment of the invention.

As the phrase is used herein, a processor may be “configured to” or “configured for” perform (or “configured for” performing) a certain function in a variety of ways, including, for example, by having one or more general-purpose circuits perform the function by executing particular computer-executable program code embodied in computer-readable medium, and/or by having one or more application-specific circuits perform the function.

Thus, as described in more detail below, embodiments of the present invention provide for utilizing email metadata to determine users of interest (i.e., users with a specified expertise in a subject matter or topic). In this regard, the present invention provides for analyzing a corpus of email metadata to determine, from subject line content, subject matters of interest (e.g., specific topics or the like), the distribution of emails associated with subject matters of interest (i.e., which users/individuals received or transmitted emails of a specific topic and the distribution groups to which users/individuals belong.

Based at least on the aforementioned data determined from analyzing the email metadata, the invention provides for creating, for each user/individual, reputation indicators, otherwise referred to as reputation scores for each subject matter that is applicable to the corresponding user/individual. The reputation indicators serve to quantify the level of knowledge or degree of relevancy that the user has in the subject matter.

Subsequently, when a requester desires to know which individuals are most knowledgeable in a specific subject matter, the requester accesses a user interface that is configured to receive input criteria that includes, at least, the subject matter and, in response, the invention provides the user with a listing of users that is ranked based on their respective reputation indicator for the specified subject matter (e.g, the user with highest reputation indicator, i.e., the user identified as the most knowledgeable in subject matter, is ranked first, the user with next highest reputation indicator is ranked second and so on).

As such the present invention is able to systematically and accurately identify users/individual(s) that are most knowledgeable in a specific subject matter. By eliminating the need to solicit for recommendations as to which individuals are most knowledgeable on a specific subject matter, the present invention eliminates the subjectivity of such manual determinations. Moreover, the present invention eliminates the inefficiencies evident in such manual determination by providing a system that is capable of providing requesters the ability to ascertain which user(s) are most knowledgeable in subject area immediately after submitting the response.

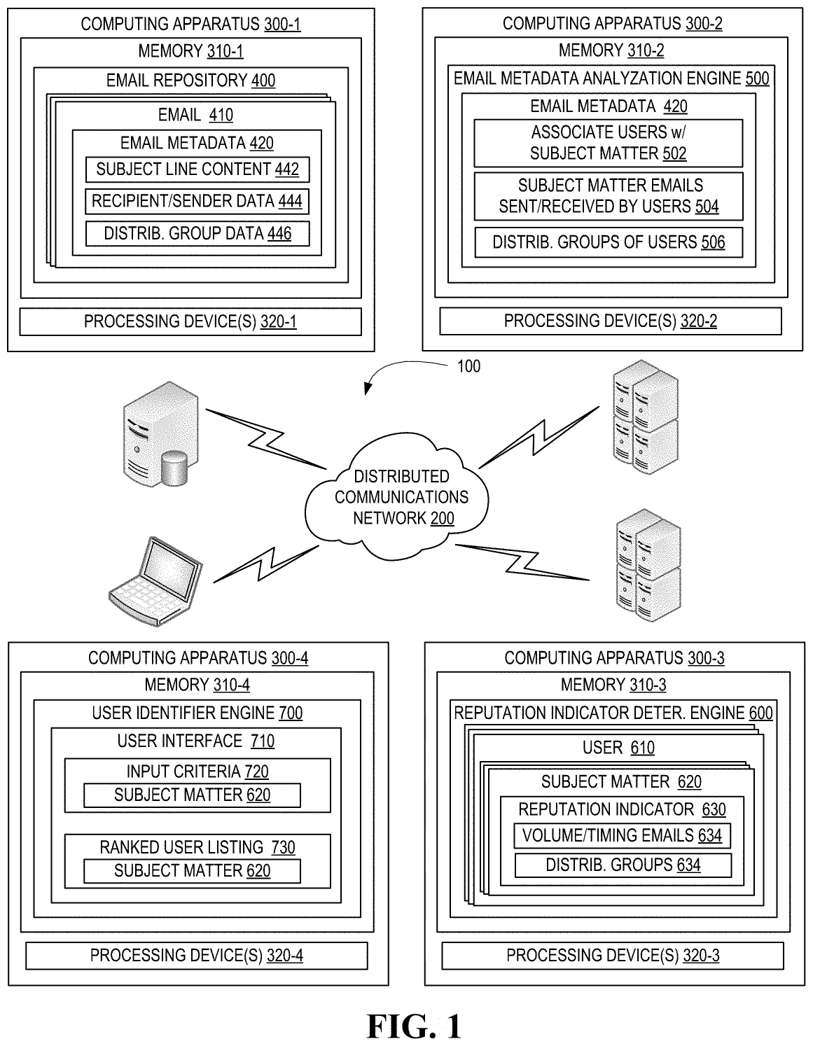

Turning now to the figures, FIG. 1 illustrates a system 100 for identifying users of interest via electronic mail metadata analysis, in accordance with embodiments of the invention. As used here the term “users of interest” may include any individual or group of individuals that meet a requester's need. For example, a user of interest may be a subject matter expert or possess a heightened level of knowledge in a specific topic or area of concern. While in certain embodiments of the invention the subject or topic may be a technical topic or field, in other embodiments of the invention the subject or topic may a completely non-technical subject or field.

The system 100 is implemented via a distributed communication network 200, such as the Internet, one or more intranets or a combination thereof. The system includes a computing apparatus 300, which may comprise one or more, and typically a plurality of, different computing devices, such as application servers, storage servers, personal computing devices and the like. The computing apparatus includes memory 310 and one or more computing device processors 320 in communication with the memory 310. Since the computing apparatus 300 typically comprises a plurality of different computing devices, the memory 310 and computing device processors 320 may be disposed amongst the plurality of computing devices.

Additionally, system 100 includes an email repository 400 stored in memory 310-1 of computing apparatus 300-1. Email repository 410 stores a corpus of electronic mail (email) 410 and the metadata 420 associated with such email. In specific embodiments of the invention, the email repository 400 may be associated with a specific email domain, as such, the volume of email held in the email repository 400 may vary in accordance with the number of individuals participating or otherwise included within the domain. Email metadata 410 as used herein is any data associated with the email 410 except the contents/body of the email itself. In order to eliminate privacy concerns, embodiments of the present invention do not rely on body of the email 410 to identify the users of interest. Thus, email metadata 420 may include, but is not limited to, the subject line contents 442, recipient/sender data 444 (i.e., who received or transmitted an email 410) and distribution group membership data 446.

In addition, system 100 includes an email metadata analyzation engine 500 that is stored in memory 310-2 of computing apparatus 300-2 and executable via processing device(s) 320-2. Engine 500 is configured to access the email repository 400 to receive and analyze the email metadata 420. The term “access” as used herein includes engine 500 making scheduled or on-demand call outs to the email repository 400 or engine 500 receiving data from the email repository 400 on a predetermined scheduled basis. The email metadata 420 is analyzed to determine, for each user (i.e., each individual email account), distribution groups 506 to which the user belongs. Further, email metadata 420 is analyzed to determine, for each user, an association 502 between a user and one or more subject matters. The associations may be based on the distribution group data 446, subject line content 442 and the like. Further, email metadata 420 is analyzed to determine, for each user, emails 410 transmitted and received 504 by user that are associated with each of the subject matters associated with the user.

Additionally, system 100 includes a reputation indicator determination engine 600 that is stored in memory 310-3 of computing apparatus 300-3 and is executable via processing device(s) 320-3. Engine 600 is configured to determine, for each of the plurality of users 610, one or more reputation indicators 630. Each of the reputation indicators 630 indicate a certain level of knowledge, competency, and/or expertise that the user 610 possesses in one of the previously determined subject matters 630. For example, if a user 610 is associated with ten (10) different subject matters 620, the user will have at least ten (10) reputation indicators 630, (i.e., at least one reputation indicator 630 for each associated subject matter 620). In specific embodiments of the invention, the reputation indicator 630 is quantified as a reputation score or the like. The reputation indicators are stored in memory 310, such as a reputation indicator database or the like. The determination of the reputation indicator 630 is based at least on (i) volume 632 of emails received and transmitted for the associated subject matter, as well as, (ii) distribution groups that the user belongs to that are associated with the subject matter. In specific embodiments of the invention, the determination of the reputation indicator 630 is based on many more aspects/parameters facets of the email metadata analyzation, including but not limited to, the timing of the emails (e.g., were the emails transmitted and received recently or in the past, were the emails mostly received and/or transmitted during a short period of time or consistently over a longer duration), the type of emails (e.g., were the emails designated as important/significant by the transmitter, do the emails pertain to a certain subject matter that denotes importance or the like).

System 100 additionally includes a user identifier engine 700 stored in memory 310-4 of computing apparatus 300-4 and executable by processing device(s) 320-4. Engine 700 is configured to receive, via user interface(s) 700, input criteria 720 from a requester that, at least identifies a subject matter 620. In specific embodiments of the invention, the input criteria 720 may include other factors such as a period of time, other secondary considerations/skills relevant or requested of the users and the like. In response to receiving the input criteria, engine 700 is configured to determine, and present to the requester via the user interface(s), a ranked user listing 730 for the subject matter 620 that is based on a level of the reputation indicator 630 for the subject matter 620. In other words, the highest ranked user in the listing 730 will have the highest level of reputation indicator (e.g., highest reputation score or the like). In other embodiments of the invention, the engine 700 determines a pool or grouping of users that have the highest level of reputation indicators (e.g., highest reputation score or the like). In specific embodiments of the invention, the listing 730 is determined by accessing storage/database that lists the users and their corresponding currently assigned reputation indicators. In this regard, the invention provides for the ranked user listing 730 to be presented to the requester in real-time or in immediate response to the requester submitting the input criteria 720. In specific embodiments of the invention, in addition to presenting the ranked user listing 730 or pooling of users with a high level of reputation indicator, additional information is presented to the user that supports the reputation indicator (i.e., the factors that went into determining the user's reputation indicator or the like.)

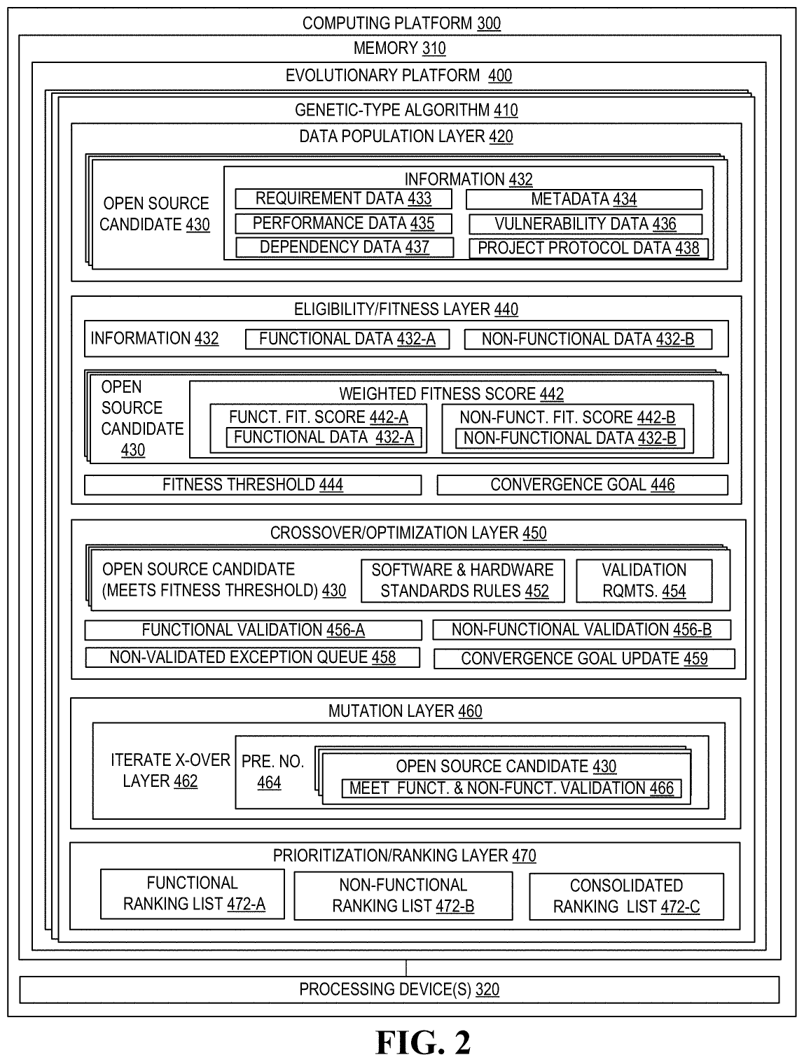

Referring to FIG. 2, a block diagram is depicted of a computing apparatus 300 configured for identifying user(s) of interest via, at least, email metadata analysis, in accordance with various alternate embodiments of the invention. Computing apparatus 300, which, as previously discussed, may comprise one or more computing devices (e.g., application server(s), storage servers, personal computing devices or the like), is configured to execute software programs, including instructions, algorithms, modules, routines, applications, tools and the like. Computing apparatus 300 includes memory 310 and the like which may comprise volatile and non-volatile memory, such as read-only and/or random-access memory (RAM and ROM), EPROM, EEPROM, flash cards, or any memory common to computing apparatus). Moreover, memory 310 and the like may comprise cloud storage, such as provided by a cloud storage service and/or a cloud connection service.

Further, computing apparatus 300 also includes one and typically a plurality of processing device(s) 320, which may be application-specific integrated circuits (“ASIC”), or other chipset, logic circuit, or other data processing devices configured to execute the email metadata analyzation engine, secondary data analyzation engines 550, reputation indicator determination engine 600 and user identification engine 700. Processing device(s) 320 or the like may execute one or more application programming interface (APIs) (not shown in FIG. 2) that interface with any resident programs, such as email metadata analyzation engine, secondary data analyzation engines 550, reputation indicator determination engine 600 and user identification engine 700 or the like stored in the memory 310 of the computing apparatus 300 and any external programs. Processing device(s) 320 may include various processing subsystems (not shown in FIG. 2) embodied in hardware, firmware, software, and combinations thereof, that enable the functionality of computing apparatus 300 and the operability of computing apparatus 300 on distributed communications network 200 (shown in FIG. 1). For example, processing subsystems allow for initiating and maintaining communications and exchanging data with other networked devices, such as email repository 400 or the like. For the disclosed aspects, processing subsystems of computing apparatus 300 may include any processing subsystem used in conjunction with email metadata analyzation engine, secondary data analyzation engines 550, reputation indicator determination engine 600 and user identification engine 700 and related engines, tools, routines, sub-routines, algorithms, sub-algorithms, sub-modules thereof.

Computing apparatus 300 may additionally include a communications module (not shown in FIG. 2) embodied in hardware, firmware, software, and combinations thereof, that enables electronic communications between computing apparatus 300 and other network devices. Thus, the communication module may include the requisite hardware, firmware, software and/or combinations thereof for establishing and maintaining a network communication connection with one or more network devices.

Memory 310 stores an email metadata analyzation engine 500 that is configured to access the email repository 400 to receive and analyze the email metadata 420. The email metadata 420 is analyzed to determine, for each user (i.e., each individual email account), associations 502 between the user and specific subject matters. Such associations 502 may be determined based subject line content of emails received or sent by a user, distribution group membership or the like. Additionally, the email metadata 420 is analyzed to determine, for each user, the emails pertaining to the associated subject matters that have been sent and/or received 504 by the user. In specific embodiments of the invention the volume of emails sent and/or received for a specified subject matter is a factor in subsequently determining the reputation indicator for the user.

Additionally, the email metadata 420 is analyzed to determine the timing 503 of receipt or delivery of emails of a specified subject matter. Subsequent determination of reputation indicators are configured to apply weighting factors to timing data, such that, if the majority of the emails were received in the near past (e.g., last week or month) versus in the far past (e.g., a year ago) a higher weighting factor may be applied when determining the reputation indicator to account for the currency of the discussions. However, in other instances, in which the requester desires to know which users were the most knowledgeable on a subject matter during a past time period (e.g., two years ago when certain changes were implemented), more emphasis/weight may be applied to the emails received during the specified past time period in determining a reputation indicator that is time dependent. Further, receiving or sending a large volume of emails on a subject matter over a long period of time may be viewed as more desirable in terms of user knowledge on the subject matter as opposed to receiving or sending the same large volume of emails on the subject matter over a short period of time (e.g., within a few days or the like).

In addition, the email metadata 420 is analyzed to determine email distribution groups 506 to which the users belong and the type/designation 508 of emails received or sent. Type/designation of emails may include emails designated as high or low importance and/or emails of a specific type (e.g., emails requesting the user to be an expert witness on a subject matter, emails requesting the user author a white paper on a subject matter or the like).

In specific embodiment of the invention, memory 310 additionally stores one or more secondary data analyzation engines 550 that are configured to access secondary data repositories to receive and analyze secondary data 560. The secondary data is used to supplement the email metadata in determining more robust and accurate reputation indicators. As previously noted, the secondary data 560 may come from internal repositories or may come from external repositories (Internet sites, publicly accessible government information databases or the like). The supplemental data may include, but is not limited to, certification data 562, education data 564, publication data 566 (including papers, books, patents and the like), group/society membership data, software development data 569 and the like.

In other specific embodiments of the invention, the system 100 includes an automated scheduled 510 configured to invoke the reputation indicator determination process on a predetermined schedule, such as weekly, monthly or the like. In certain instances, the enormous size of the email repository and other data sources prohibits dynamic execution of the reputation determination process in response to a request for user(s) of interest. As such, the process is generally scheduled for automatic execution on a predetermined schedule or, in some embodiments on an as-needed basis. In addition, in those embodiments of the invention in which the reputation indicators are determined from additional data source other than the email metadata, the system 100 may include coordinators 520 that are invoked by the automated scheduler 510 and are configured to synchronize with each other to make certain that the subsequent analysis performed on the email metadata and the supplemental data is performed in logical synchronization to accommodate the time dependencies of the data analysis.

Additionally, memory 310 a reputation indicator determination engine 600 that is configured to determine, for each of the plurality of users 610, one or more reputation indicators 630. Each of the reputation indicators 630 indicate a certain level of knowledge, competency, and/or expertise that the user 610 possesses in one of the previously determined subject matters 630. Alternatively, each user has a multipart reputation indicator with each part corresponding to a different subject matter. For example, if a user 610 is associated with ten (10) different subject matters 620, the user will have at least ten (10) reputation indicators 630, (i.e., at least one reputation indicator 630 for each associated subject matter 620) or a multipart reputation indicator comprising at least 10 parts. In specific embodiments of the invention, the reputation indicator 630 is quantified as a reputation score or the like. Once determined, the reputation indicators are stored in memory, such as a reputation indicator database or the like for subsequent access in response to receiving a request for user(s) of interest. The determination of the reputation indicator 630 is based at least on (i) volume 632 of emails received and transmitted for the associated subject matter, as well as, (ii) distribution groups that the user belongs to that are associated with the subject matter. In specific embodiments of the invention, the determination of the reputation indicator 630 is based on many more aspects/parameters facets of the email metadata analyzation, including but not limited to, the timing 636 of the emails (e.g., were the emails transmitted and received recently or in the past, were the emails mostly received and/or transmitted during a short period of time or consistently over a longer duration), the type 638 of emails (e.g., were the emails designated as important/significant by the transmitter, do the emails pertain to a certain subject matter that denotes importance or the like) and the secondary data 560.

Memory 310 of computing apparatus 300 additionally stored user identifier engine 700 that is configured to receive, via user interface(s) 710, input criteria 720 from a requester that, at least identifies a subject matter 620. In specific embodiments of the invention, the input criteria 720 may include other criteria 722 such as a time period 724, team criteria 726 or any other secondary considerations/skills relevant or requested of the users and the like. In response to receiving the input criteria, engine 700 is configured to determine, and present to the requester via the user interface(s), a ranked user listing 730 for the subject matter 620 that is based on a level of the reputation indicator 630 for the subject matter 620. In other words, the highest ranked user in the listing 730 will have the highest level of reputation indicator (e.g., highest reputation score or the like). In other embodiments of the invention, the engine 700 determines a pool or grouping of users that have the highest level of reputation indicators (e.g., highest reputation score or the like). In other embodiments of the invention, the requester is presented with a virtual team 740 comprising multiple different users, each user possessing a certain level of knowledge/expertise in one or more subject matters 620. In specific embodiments of the invention, the listing 730 or virtual team 740 is determined by accessing storage/database that lists the users and their corresponding currently assigned reputation indicators. In this regard, the invention provides for the ranked user listing 730 or virtual team 740 to be presented to the requester in real-time or in immediate response to the requester submitting the input criteria 720. In specific embodiments of the invention, in addition to presenting the ranked user listing 730 or virtual team 740, additional information is presented to the user that supports the reputation indicator (i.e., the factors that went into determining the user's reputation indicator or the like) or indicated the current and/or future availability of the users of interest.

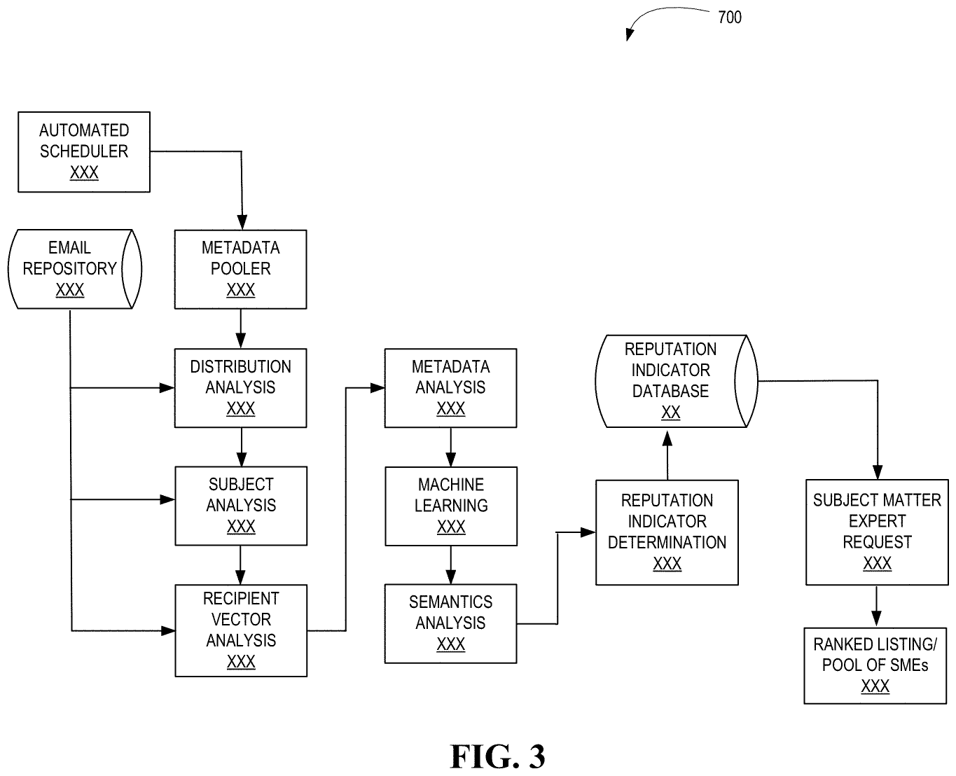

Referring to FIG. 3, a block/flow diagram is depicted of a system 800-1 for identifying users of interest via analysis of email metadata, in accordance with embodiments of the invention. At Event 510, an automated scheduler is invoked on a predetermined schedule to initiate the determination of reputation indicators for the users (i.e., email account holders). For example, the automated scheduler may be invoked on a weekly basis, bi-weekly basis or the like.

At Event 802 the metadata pooler analysis is invoked to build a table of email metadata for each email account (i.e., each user or group of users). At Event 804, distribution analysis of the email metadata is conducted to build a database of users that are indexed/included with distribution groups. At Event 806, subject matter analysis of the subject line content is performed to build a database of users that are associated with specific subject matters. At Event 808, recipient vector analysis is performed to build a database of users indexed by subject matter and recipient vector (i.e., to which users and/or distribution groups the email is addressed to and/or copied to).

At Event 810, the databases built in Events 802, 804 and 806 are accessed and metadata analysis is conducted to perform database joins, unions and differences to build a database, persisted in a temporary object store, for subsequent machine learning. At Event 812, unsupervised machine learning and clustering techniques are performed on data from the previously built database (Event 810) to identify patterns in the data and nodes of interest as data entries for subsequent semantics analysis. At Event 812, semantics analysis is performed to identify nodes of focal interest (i.e., subject matter). In this regard semantics analysis provides for assessing the level of interest that a user may have in a subject matter based on email activity and the like.

At Event 816, the multipart reputation indicators, for each user, are determined by analyzing temporal considerations (e.g., recent-analysis) and the metadata resulting from Events 810, 812 and 814. The multipart indicates a reputation indicator/score for each subject matter associated with the user. At Event 820, the reputational indicators are stored in a database/repository that associates users with their corresponding multipart reputation indicator/score.

At Event 830, a subject matter expert or the like request is made that includes, at least, the subject matter of interest and, in response, the reputational indicator database is accessed and analyzed to render a ranked user listing for the subject matter ranked based on the level of reputation indicator/score or a grouping of users have a specified level of reputation indicator/score for the subject matter. At Event 730, the ranked user listing or group of users is presented to the requester and, in some embodiments, data that justifies the ranking (i.e., email volume received and/or sent on the subject matter, distribution groups and the like).

In additional, in instances in which immediate availability or availability for a future time period of the user(s) of interest is desired, the ranked user listing may additionally indicate which of the users are currently available or which of the users are available during the future time period. Alternatively, the ranked user listing may be paired down to include those users that are currently available or those users available during the future time period. User availability data may be determined by accessing the user's calendar application or any other application that tracks user availability.

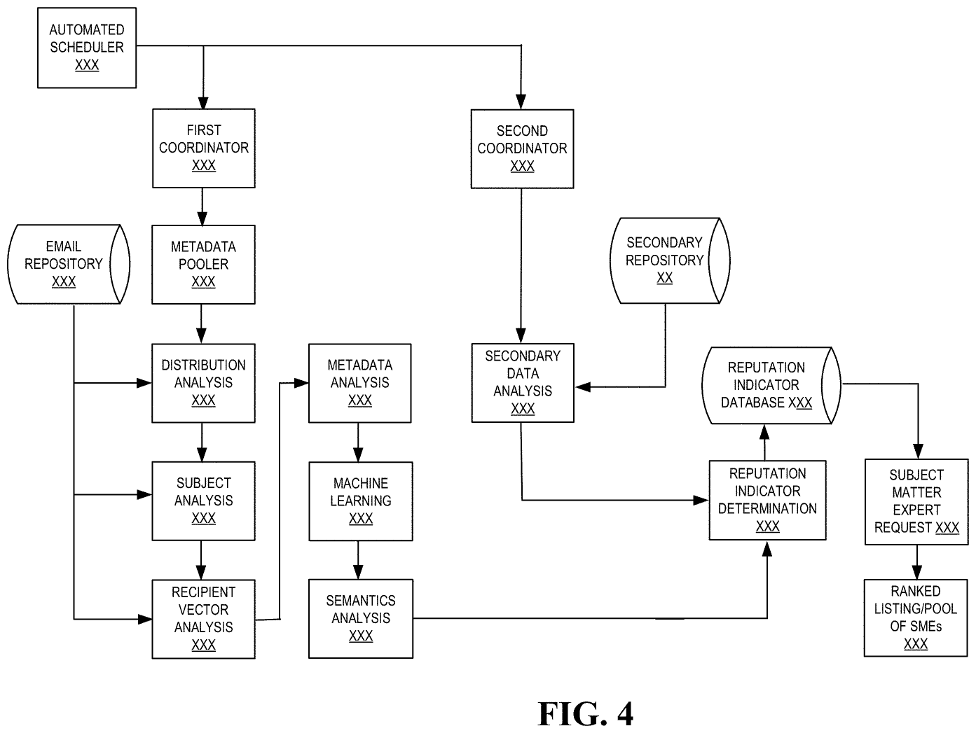

Referring to FIG. 4, a block/flow diagram is depicted of a system 800-2 for identifying users of interest via analysis of email metadata and secondary data, in accordance with embodiments of the invention. Similar to the system of FIG. 3, at Event 510, an automated scheduler is invoked on a predetermined schedule to initiate the determination of reputation indicators for the users (i.e., email account holders). In the embodiment shown in FIG. 4, the automated scheduler invokes the first and second coordinators (Events 520-1, 520-2). At Events 520-1 and 520-2 the first and second coordinators are logically synchronized with each other for sequencing purposes. The synchronization is required in the event that the email metadata analysis and the secondary data analysis have time dependent components. In those embodiments in which multiple different secondary data analysis is performed, the system 800-2 may include more than two coordinators in the event that the additional secondary data analysis has a time dependent component. Events 802-814 are associated with email metadata analysis and are the same events described in relation to FIG. 3. Therefore, for the sake of brevity, Events 802-814 will not be discussed in relation to FIG. 4.

At Event 852, the secondary repository is accessed to retrieve and analyzes secondary data. As previously discussed, the secondary repository may be an internal repository (i.e., internal to the organization conducting identification of users of interest) or an external repository (e.g., a publicly accessible Internet site or the like). The secondary data may include, but is not limited to, software development data, certification data, educational credential data, publication data and the like.

At Event 816, the multipart reputation indicators, for each user, are determined by analyzing temporal considerations (e.g., recent-analysis) and the email metadata resulting from Events 810, 812 and 814 and the secondary data resulting from Event 852. The multipart indicates a reputation indicator/score for each subject matter associated with the user. At Event 820, the reputational indicators are stored in a database/repository that associates users with their corresponding multipart reputation indicator/score. Events 830 and 730, are associated with requesting subject matter experts and presenting the results to a requester and are the same events described in relation to FIG. 3. Therefore, for the sake of brevity, Events 830 and 730 will not be discussed in relation to FIG. 4.

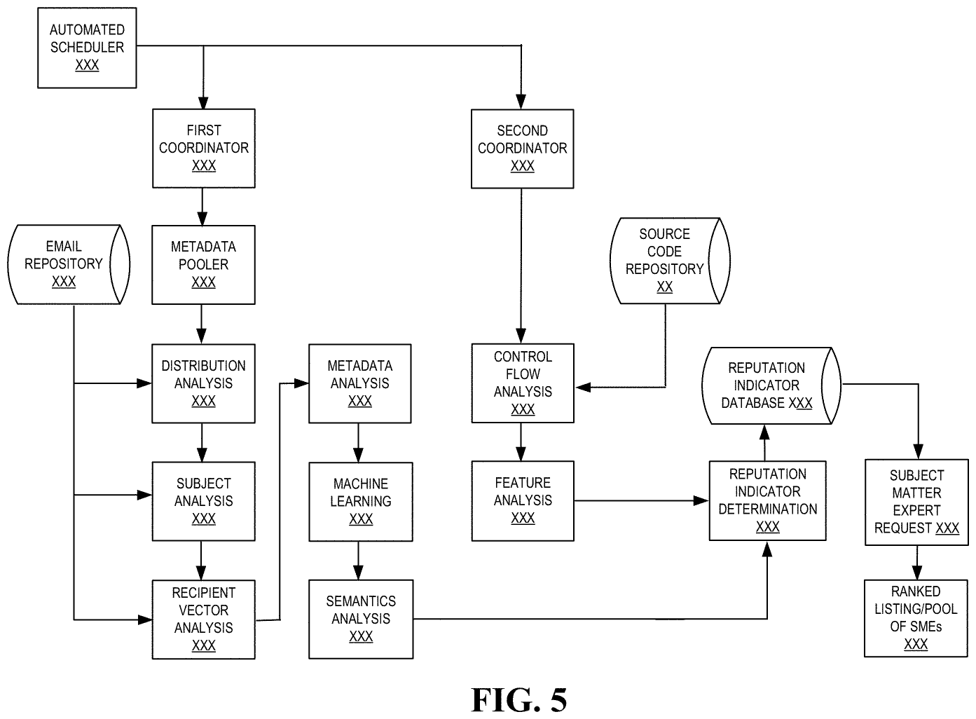

Referring to FIG. 5, a block/flow diagram is depicted of a system 800-2 for identifying users of interest via analysis of email metadata and software development data, in accordance with embodiments of the invention. Similar to the system of FIG. 3, at Event 510, an automated scheduler is invoked on a predetermined schedule to initiate the determination of reputation indicators for the users (i.e., email account holders). In the embodiment shown in FIG. 5, the automated scheduler invokes the first and second coordinators (Events 520-1, 520-2). At Events 520-1 and 520-2 the first and second coordinators are logically synchronized with each other for sequencing purposes. Events 802-814 are associated with email metadata analysis and are the same events described in relation to FIG. 3. Therefore, for the sake of brevity, Events 802-814 will not be discussed in relation to FIG. 5.

At Event 852-1, the source code repository is accessed to retrieve source code and related development data (e.g., check-in, check-out data and the like) to perform control flow analysis, which creates abstract syntax tree control flow graphs and identifies human code nodes in correlation with source code repository commits. At Event 852-2, the results of Event 852-1 are inputs to feature analysis, which identifies practitioner/developer code commits, including language and framework relevance.

At Event 816, the multipart reputation indicators, for each user, are determined by analyzing temporal considerations (e.g., recent-analysis) and the email metadata resulting from Events 810, 812 and 814 and the observation data from Events 852-1 and 852-2 as reinforced by code commits. At Event 820, the reputational indicators are stored in a database/repository that associates users with their corresponding multipart reputation indicator/score. Events 830 and 730, are associated with requesting subject matter experts and presenting the results to a requester and are the same events described in relation to FIG. 3. Therefore, for the sake of brevity, Events 830 and 730 will not be discussed in relation to FIG. 5.

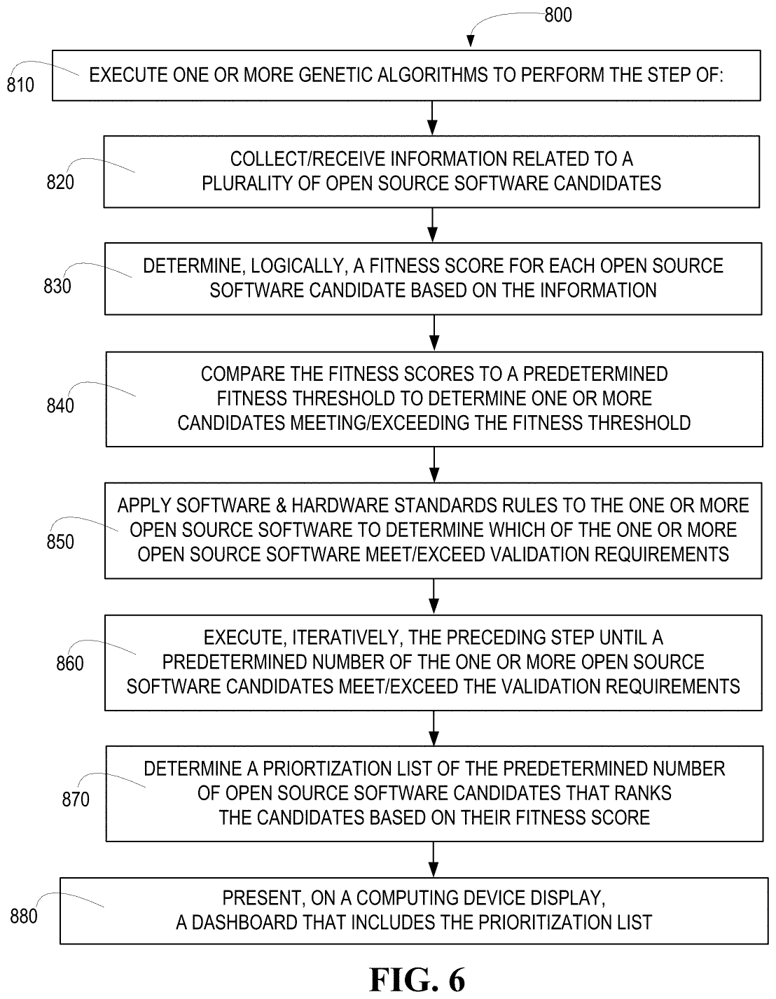

Referring to FIG. 6, a flow diagram is presented of a methodology 900 for identifying users of interest via email metadata analysis, in accordance with embodiments of the present invention. At Event 910, an email repository is accessed and email metadata only (i.e., not the content/body of the emails) is analyzed to determine for each user (i.e., each individual email account), at least (i) associations between users and one or more subject matters, (ii) emails associated with the one or more subject matters that have been received or transmitted by the user and (iii) distribution groups to which the users belong. In alternate embodiments of the method, the analyzation of the email metadata additionally determines the timing of receipt/transmission of the emails, the type/designation of the emails and any other metadata associated with the emails.

At Event 920, for each of the users, at least one reputation indicator is determined based, at least, on (i) volume of emails received and transmitted that are associated with an associated subject matter and, (ii) the group memberships to which the user belongs that are associated with the associated subject matter. Each reputation indicator is associated with one of the subject matters associated with the user. As previously discussed, the reputation indicator indicates a level of knowledge, expertise or the like that the user has in the subject matter. In other embodiments of the invention, the reputation indicator is based on other email metadata, such as timing of the emails, type of emails and the like. In additional embodiments of the invention, other supplemental data may also be the basis for reputation indicators. Such supplemental data may come from internal repositories or external repositories (e.g., public Internet sites) or the like. The supplemental data may include, but is not limited to, software development data, certification data, educational credential data, publication data (e.g., articles, books, patents and the like), group/society membership data and the like.

At Event 930, input criteria for identifying a user of interest is received from a requester that identifies, at least, a subject matter. In additional embodiments of the method, the input criteria may include other criteria, such as a time period (e.g., current or past), other features/aspects of the user of interest (e.g., public speaker, author or the like) and the like.

At Event 940, in response to receiving the input criteria, a ranked user listing or grouping of users for the subject matter is determined and presented to the requester. The ranked listing or grouping of users includes one or more users ranked or included in the group based on their respective level of reputation indicator for the subject matter. In additional embodiments of the method, the requester is also presented with the data used to determine the reputation indicator, volume of emails received/transmitted, group membership or other supplemental data, such as, but not limited to, software development data, certification data, educational credential data, publication data and the like.

As evident from the preceding description, the systems, methods and the like described herein represents an improvement in technology, specifically, embodiments of the present invention provide for analyzing email metadata, and in specific embodiments other related data, to identify users of interest (i.e., users/email account holders having knowledge or expertise in a subject matter). Specifically, a corpus of email metadata is analyzed to determine, at least, which subject matters are associated with users, which users received or transmitted subject matter-specific emails, the distribution groups to which users, and any other relevant email metadata. In additional embodiments, secondary data other than email metadata is also analyzed and used to identify the users of interest. The analyzed email metadate, and in some embodiments the secondary data, is used to render reputation indicator(s) for each user that indicate a level of knowledge/expertise that the user possesses on subject matter(s). A requester provides input criteria including the subject matter, and, in response, is presented a ranked user listing that is ranked based on the level of reputation indictor.

Those skilled in the art may appreciate that various adaptations and modifications of the just described embodiments can be configured without departing from the scope and spirit of the invention. Therefore, it is to be understood that, within the scope of the appended claims, the invention may be practiced other than as specifically described herein.

1. A system for identifying users of interest though analysis of electronic mail (email), the system comprising:
a plurality of computing apparatus including a memory and one or more processors in communication with the memory;
an email repository stored in the memory and configured to store email that has been transmitted and received by a plurality of users, wherein the email includes metadata comprising (i) subject line content, (ii) email recipient and sender data, and (iii) distribution group membership;
an email metadata analyzation engine stored in the memory, executable by one or more of the processors and configured to access the email repository and analyze only the metadata of the emails to determine, for each user, (i) an association between a user and one or more subject matters identified from subject line content, (ii) emails associated with each of the one or more subject matters received and transmitted by the user, and (iii) distribution groups to which the user is a member;
a reputation indicator determination engine stored in the memory, executable by one or more of the processors and configured to determine, and store in the memory, for each of the users one or more reputation indicators, wherein each reputation indicator is associated with a subject matter and is based at least on (i) volume of emails associated with each of the subject matters that have been received and transmitted by the user, and (ii) distribution groups to which the user is a member; and
a user identifier engine stored in the memory, executable by one or more of the processors and configured to:
receive input criteria from a requester that identifies a subject matter, and determine, and present to the requester, a ranked user listing for the subject matter, wherein the ranked user listing comprises one or more users ranked based on a level of the reputation indicator for the subject matter.

2. The system of claim 1, further comprising:
one or more secondary data repositories stored in the memory and configured to store data associated with the plurality of users; and
one or more data analyzation engines stored in the memory, executable by one or more of the processors and configured to access one or more of the secondary data repository engines and analyze the data to determine associations between the subject matters and users.

3. The system of claim 2, wherein the reputation indicator determination engine is further configured to determine for each of the users one or more reputation indicators, wherein each reputation indicator is associated with a subject matter and is based further on the associations between the subject matter and the user determined from the data stored in the secondary data repositories.

4. The system of claim 2, further comprising:
a plurality of coordinators, wherein one coordinator is associated with the email metadata analyzation engine and the other coordinators are associated with one of the one or more data analyzation engines, wherein the coordinators are configured to logically synchronize actions performed by the email metadata analyzation engine and the one or more data analyzation engines.

5. The system of claim 1, further comprising:
an automated scheduler stored in the memory, executable by the processor and configured to execute the email metadata analyzation on a predetermined schedule or in response to a trigger event.

6. The system of claim 2, wherein the one or more secondary data repositories include one or more of (i) an internal user data repository and (ii) an external data repository.

7. The system of claim 6, wherein the one or more secondary data repositories store the data associated with the users, wherein the data includes at least one of (i) certifications associated with the users, (ii) education credentials associated with the users, (ii) publications authored by the users, (iii) group memberships associated with the users.

8. The system of claim 2, wherein the one or more secondary data repositories further comprise:
a source code repository stored in the memory and configured to store source code developed by a plurality of the users; and
wherein the data analyzation engine further comprises
a source code analyzation engine stored in the memory, executed by one or more of the processors and configured to determine logical execution of control flow of source codes to identify, from the control flow, subject matters associated with users.

9. The system of claim 8, wherein the reputation indicator determination engine is further configured to determine for each of the users the one or more reputation indicators, wherein at least one of the reputation indicators is further based on the subject matters associated with the user identified from the control flow of the source code.

10. The system of claim 1, wherein the user identifier engine is further configured to receive input criteria from a requester that identifies other user criteria and determine the ranked user listing for the subject matter based further on the other user criteria.

11. The system of claim 1, wherein the user identifier engine is further configured to receive input criteria from a requester that identifies a period of time associated with the ranked user listing for the subject matter and determine the ranked user listing for the subject matter over the identified period of time.

12. The system of claim 1, wherein the user identifier engine is further configured to determine at least one of current and future availability of the users in the ranked user listing.

13. The system of claim 1, wherein the user identifier engine is further configured to:
receive input criteria from a requester that identifies a plurality of subject matters needed to form a team of users, and
determine, and present to the requester, at least one of (i) a plurality of ranked user listings for each of the plurality of subject matter, wherein the ranked user listings comprises one or more users ranked based on a level of the reputation indicator for the subject matter and (ii) a team of users, each user in the team determined based at least on the level of the reputation indicator for one of the plurality of subject matters.

14. A computer-implemented method for identifying user of interests though analysis of electronic mail (email), the method executed by one or more computer processing devices and comprising:
accessing an email repository and analyzing only the metadata of the emails to determine, for each user, (i) an association between a user and one or more subject matters identified from subject line content, (ii) emails associated with each of the one or more subject matters received and transmitted by the user, and (iii) distribution groups to which the user is a member;
determining, and storing in memory, for each of the users one or more reputation indicators, wherein each reputation indicator is associated with a subject matter and is based at least on (i) volume of emails associated with each of the subject matters that have been received and transmitted by the user, and (ii) distribution groups to which the user is a member;
receiving input criteria from a requester that identifies a subject matter;
in response to receiving the input criteria, determining, and presenting to the requester, a ranked user listing for the subject matter, wherein the ranked user listing comprises one or more users ranked based on a level of the reputation indicator for the subject matter.

15. The computer-implemented method of claim 14, further comprising:
accessing one or more of the secondary data repository engines and analyzing the data to determine associations between the subject matters and users,
wherein determining for each of the users the one or more reputation indicators further comprises determining for each of the users the one or more reputation indicators based further on the associations between the subject matter and the user determined from the data stored in the secondary data repositories.

16. The computer-implemented method of claim 15, further comprising:
performing (i) accessing the email repository and analyzing only the metadata of the emails, and (ii) accessing one or more of the secondary data repository engines and analyzing the data on a predetermined schedule or in response to a trigger event; and
logically synchronizing (i) accessing the email repository and analyzing only the metadata of the emails, and (ii) accessing one or more of the secondary data repository engines and analyzing the data.

17. The computer-implemented method of claim 14, wherein receiving the input criteria from the requester further comprises receiving the input criteria from the requester that identifies a period of time associated with the ranked user listing for the subject matter and determining the ranked user listing for the subject matter further comprises determining the ranked user listing for the subject matter over the identified period of time.

18. A computer program product including non-transitory computer-readable medium that comprises:
a first set of codes for causing a computer to access an email repository and analyze only the metadata of the emails to determine, for each user, (i) an association between a user and one or more subject matters identified from subject line content, (ii) emails associated with each of the one or more subject matters received and transmitted by the user, and (iii) distribution groups to which the user is a member;
a second set of codes for causing a computer to determine, and store in memory, for each of the users one or more reputation indicators, wherein each reputation indicator is associated with a subject matter and is based at least on (i) volume of emails associated with each of the subject matters that have been received and transmitted by the user, and (ii) distribution groups to which the user is a member;
a third set of codes for causing a computer to receive input criteria from a requester that identifies a subject matter;
a fourth set of codes for causing a computer, in response to receiving the input criteria, determine, and present to the requester, a ranked user listing for the subject matter, wherein the ranked user listing comprises one or more users ranked based on a level of the reputation indicator for the subject matter.

19. The computer program product of claim 18, wherein the computer-readable medium further comprises:
a fifth set of codes for causing the computer to access one or more of the secondary data repository engines and analyzing the data to determine associations between the subject matters and users;
wherein the second set of codes is further configured to determine for each of the users the one or more reputation indicators based further on the associations between the subject matter and the user determined from the data stored in the secondary data repositories.

20. The computer program product of claim 19, wherein the computer-readable medium further comprises:
a sixth set of codes for causing a computer to perform (i) accessing the email repository and analyzing only the metadata of the emails, and (ii) accessing one or more of the secondary data repository engines and analyzing the data on a predetermined schedule or in response to a trigger event; and
a seventh set of codes for causing a computer to logically synchronize (i) accessing the email repository and analyzing only the metadata of the emails, and (ii) accessing one or more of the secondary data repository engines and analyzing the data.
